(19) United States
(12) Patent Application Publication
(10) Pub. No.: US 2004/0131902 A1
(43) Pub. Date: Jul. 8, 2004

(54) Regenerative power supply system and components thereof

(75) Inventors: David Frank, Scarborough (CA); Nathaniel Ian Joos, Toronto (CA); Ali Rusta-Sallehy, Richmond Hill (CA); Daren Pemberton, Milton (CA); Gabriel Hourtouat, Toronto (CA)

Correspondence Address: BERESKIN AND PARR, SCOTIA PLAZA, 40 KING STREET WEST-SUITE 4000 BOX 401, TORONTO, ON, M5H 3Y2, CA

(73) Assignee: Hydrogenics Corporation, Mississauga (CA)

(21) Appl. No.: 10/722,545

(22) Filed: Nov. 28, 2003

Related U.S. Application Data
(60) Provisional application No. 60/429,310, filed on Nov. 27, 2002.
(60) Provisional application No. 60/504,227, filed on Sep. 22, 2003.

(51) Int. Cl. H01M 8/18; H01M 8/04

(52) U.S. Cl. 429/21; 429/24; 429/26; 429/25

(57) ABSTRACT

A mobile power supply system for use in vehicles, and components of the mobile power supply system. The power supply system is a regenerative fuel cell system. The system combines a fuel cell unit, an electrolyzer unit, and a hydrogen storage unit. Design improvements over known regenerative fuel cell systems are incorporated into the system of the present invention.

The present application is a non-provisional application of U.S. patent application Ser. No. 60/429,310 filed Nov. 27, 2002 and of U.S. patent application No. 60/__,__filed Sep. 22, 2003, the contents of which are herein incorporated by reference.

### FIELD OF THE INVENTION

The present invention relates generally to mobile power supply systems for use in vehicles, and more particularly to regenerative systems that combine a fuel cell unit, an electrolyzer unit, and a hydrogen storage unit, and components thereof.

### BACKGROUND OF THE INVENTION

There are several instances where a mobile power supply (e.g. as an uninterruptible power supply (UPS) or auxiliary power unit (APU)) is desirable or needed. For example, the mobile power supply may be used to provide electric power on-board a vehicle, such as a car, bus, truck, boat, or recreational vehicle (RV).

Fuel cells have been proposed as a clean, efficient and environmentally friendly power source having various applications. A conventional proton exchange membrane (PEM) fuel cell, for example, is typically comprised of an anode, a cathode, and a selective electrolytic membrane disposed between the two electrodes. A fuel cell generates electricity by bringing a fuel gas (typically hydrogen) and an oxidant gas (typically oxygen) to the anode and the cathode respectively. In reaction, the fuel gas is oxidized at the anode to form cations (protons) and electrons by the reaction H₂=2H⁺+2e⁻. The proton exchange membrane facilitates the migration of protons from the anode to the cathode, while preventing the electrons from passing through the membrane. As a result, the electrons are forced to flow through an external circuit thus providing an electrical current. At the cathode, oxygen reacts with electrons returned from the electrical circuit to form anions. The anions formed at the cathode react with the protons that have crossed the membrane to form liquid water as a reaction by-product following ½O₂+2H⁺+2e⁻=H₂O.

On the other hand, an electrolyzer uses electricity to electrolyze water, to generate oxygen from its anode and hydrogen from its cathode. Similar to a fuel cell, a typical solid polymer water electrolyzer (SPWE) or proton exchange membrane (PEM) electrolyzer is also comprised of an anode, a cathode, and a proton exchange membrane disposed between the two electrodes. Water is introduced to, for example, the anode of the electrolyzer, which is connected to the positive pole of a suitable direct current voltage. Oxygen is produced at the anode of the electrolyzer by the reaction H₂O=½O₂+2H⁺+2e⁻. The protons then migrate from the anode to the cathode through the membrane. At the cathode, which is connected to the negative pole of the direct current voltage, the protons conducted through the membrane are reduced to hydrogen following 2H⁺+2e⁻=H₂.

One known type of regenerative fuel cell system combines separate fuel cell and electrolyzer units, where the fuel cell unit generates electricity while consuming fuel gas (typically hydrogen) and oxidant (typically oxygen or air) in an electricity generation mode, and where the electrolyzer unit consumes electricity and water in a hydrogen generation mode to generate the two process gases (i.e. hydrogen and oxygen) for consumption by the fuel cell unit. Individual fuel cells are usually interconnected in a series arrangement, often called “stacks”. Similarly, individual electrolyzer cells are also usually interconnected in stacks.

Some examples of known regenerative fuel cell systems are described in U.S. Pat. Nos. 5,376,470 and 5,506,066 issued to Rockwell International Corporation, and in U.S. Pat. No. 6,516,905 issued to Ballard Power Systems AG.

### SUMMARY OF THE INVENTION

The present invention relates generally to a mobile power supply system that provides for certain improvements over known regenerative fuel cell systems, and components thereof.

In one broad aspect of the present invention, there is provided a power supply system comprising: a hydrogen storage module; a fuel cell power module coupled to the hydrogen storage module, the fuel cell power module comprising at least one fuel cell having an anode and a cathode; an electrolyzer module coupled to the hydrogen storage module, the electrolyzer module comprising at least one electrolyzer cell having an anode and a cathode; and a control module coupled to the hydrogen storage, fuel cell power, and electrolyzer modules; wherein the system is operable in at least a hydrogen generation mode where hydrogen gas is generated by the at least one electrolyzer cell received thereby for storage in the hydrogen storage module, and an electricity generation mode where hydrogen gas is retrieved from the hydrogen storage module and used by the at least one fuel cell unit to produce electric energy.

In another broad aspect of the present invention, there is provided an electrolyzer module comprising at least one temperature regulation device coupled to at least one electrolyzer cell for varying the operating temperature of the at least one electrolyzer cell, such that the current draw of the at least one electrolyzer cell is controlled.

In another broad aspect of the present invention, there is provided an electrolyzer module comprising a pressure regulating device coupled to one of the anode and cathode of at least one electrolyzer cell, wherein gas at the other of the anode and cathode of the at least one electrolyzer cell is used to control the operation of the pressure regulating device, such that a substantially constant differential pressure between the anode and cathode of the at least one electrolyzer cell is maintained.

In another broad aspect of the present invention, there is provided an electrolyzer module comprising a drying unit coupled to the cathode of at least one electrolyzer cell, and wherein the electrolyzer module further comprises a pressure regulating device coupled between the cathode and the drying unit, such that pressure fluctuations of the drying unit are isolated from the cathode.

In another broad aspect of the present invention, there is provided an electrolyzer module comprising a pump adapted to provide water to at least one electrolyzer cell at a flow rate and at sufficiently low pressure so that a determined differential pressure limit is not exceeded, and wherein in operation, water is supplied to the at least one electrolyzer cell in the hydrogen generation mode by the pump at a rate associated with a desired rate of hydrogen production by the electrolyzer module.

In another broad aspect of the present invention, there is provided a fuel cell power module comprising at least one oxidant supplying device to supply oxygen-containing gas to at least one fuel cell, such that the rate at which the gas is supplied by the at least one oxidant supplying device is a function of at least the current draw on the at least one fuel cell during operation of the at least one fuel cell in the electricity generation mode.

In another broad aspect of the present invention, there is provided a fuel cell power module comprising a pressure regulating device coupled to one of the anode and cathode of at least one fuel cell, wherein gas at the other of the anode and cathode of the at least one fuel cell is used to control the operation of the pressure regulating device, such that a substantially constant differential pressure between the anode and cathode of the at least one fuel cell is maintained.

In another broad aspect of the present invention, there is provided an electrolyzer module comprising a determined number of electrolyzer cells having an active area such that at least one electrolyzer cell can be directly connected to a power source of a vehicle to receive power from the power source in hydrogen generation mode, and a fuel cell power module comprising a determined number of fuel cells having an active area such that at least one fuel cell can be directly connected to supply power to the vehicle in electricity generation mode.

In another broad aspect of the present invention, there is provided a hydrogen storage module comprising a storage unit of one or more cylinders, each containing metal hydrides, for storing hydrogen generated by at least one electrolyzer cell; and wherein the hydrogen storage module further comprises a water circulation system coupled to the storage unit and at least one fuel cell, wherein water is circulated in the water circulation system in at least one of the hydrogen generation and electricity generation modes.

It will be understood by persons skilled in the art that different aspects of the present invention can be implemented in various combinations, in variant implementations and embodiments of the present invention.

### BRIEF DESCRIPTION OF THE DRAWINGS

For a better understanding of the present invention and to show more clearly how it may be carried into effect, reference will now be made, by way of example, to the accompanying drawings, which show embodiments of the present invention and in which:

FIG. 1 is a schematic diagram illustrating the modules of a mobile power supply system in an embodiment of the present invention;

FIG. 2 is a flow chart illustrating steps in an operating process of the embodiment of the mobile power supply system shown in FIG. 1; and

FIG. 3 is a schematic diagram illustrating the components of the modules of the embodiment of the mobile power supply system shown in FIG. 1 in further detail.

### DETAILED DESCRIPTION OF EMBODIMENTS OF THE INVENTION

The present invention is directed generally to an improved mobile power supply system and components thereof. In one embodiment of the present invention, the mobile power supply system is a regenerative system that combines a fuel cell stack, an electrolyzer stack, and a hydrogen storage unit.

Operation of a fuel cell stack in a regenerative fuel cell system requires the administration of anode and cathode reactant gases for use in the oxidation and reduction half reactions. The ratio of actual flow to required flow of these gases, or stoichiometry, is important as both too much and too little flow have negative impacts on fuel cell stack performance and overall system efficiency. For example, different stoichiometries may be required at different fuel cell stack output rates and at different current densities, to balance the needs for optimal fuel cell stack operation with maximum system efficiency. Therefore, the flow rates of both reactants must be controlled to achieve an optimized system performance. At least one aspect of an embodiment of the present invention addresses this need.

Electrolyzer stack performance is also a key design parameter in a regenerative fuel cell system for a number of reasons: it typically constitutes the largest, single-component cost; it defines the maximum hydrogen recharge rate for a given power supply; its efficiency is a major factor in the calculation of the overall efficiency of the regenerative fuel cell system; high power electronics hardware used to power known electrolyzer stacks is typically large, heavy, and expensive; and it typically has a through-life variation in the current-voltage characteristic. As a result, an electrolyzer stack must be carefully designed to minimize cost and maximize performance throughout the life of the system. At least one aspect of an embodiment of the present invention addresses this need.

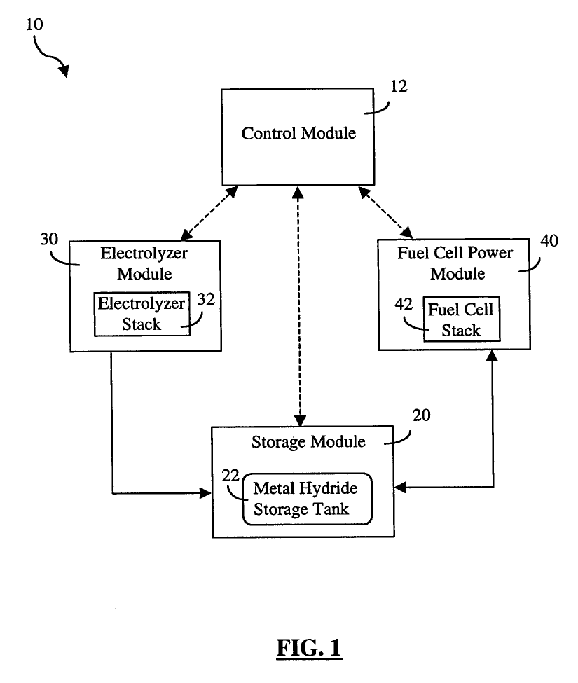

Referring to FIG. 1, a schematic diagram illustrating the modules of a mobile power supply system in an embodiment of the present invention is shown generally as 10.

Mobile power supply system or mobile power generating system 10 comprises a number of specialized modules whose operations are governed by a control system or control module 12. In this embodiment of the invention, these specialized modules of system 10 include a storage module 20 having a metal hydride storage tank 22, an electrolyzer module 30 having an electrolyzer stack 32, and a fuel cell power module 40 having a fuel cell stack 42.

In the operation of system 10, control module 12 communicates with and controls various switches, valves, regulators, monitors, sensors, filters, and other components of the modules of system 10. Control module 12 comprises at least one programmable logic controller (PLC) coupled to system 10. Control module 12 is coupled to a user interface [not shown] in which operating data may be displayed as output to operators of system 10, and which may allow operators to set various operating parameters for system 10, for example. The user interface may also provide for user-operable switches to allow operators of system 10 to control the power to system 10, and to select between different operating modes, for example.

During normal active operation of system 10, system 10 operates in one of the following two operating modes: a hydrogen generation mode (“CHARGE METAL HYDRIDES”) and an electricity generation mode (“GENERATE ELECTRICITY”).

In the hydrogen generation mode, electricity (e.g. as supplied by a vehicle alternator) and feed water are supplied as inputs to electrolyzer stack 32 of electrolyzer module 30. Electrolyzer stack 32 of electrolyzer module 30 generates hydrogen and oxygen from these inputs. Generated hydrogen is directed to storage module 20, in which the hydrogen is stored in metal hydride storage tank 22, comprising one or more metal hydride cylinders. Generated oxygen can be vented to the ambient air, for example.

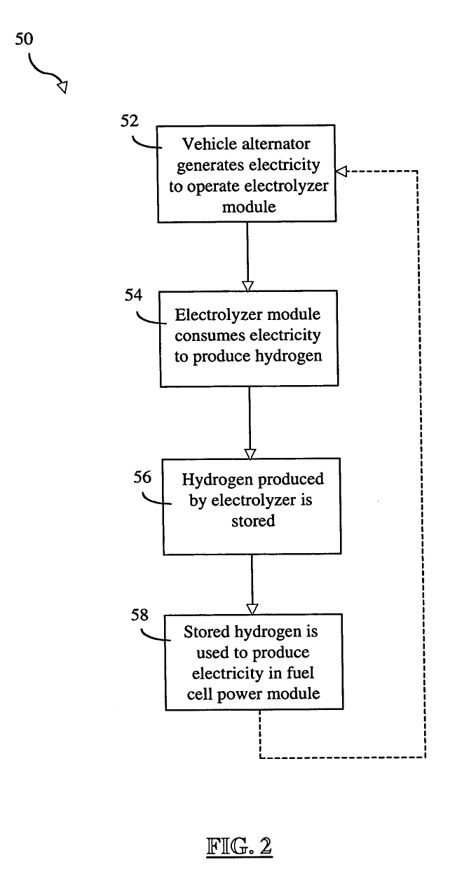

In the electricity generation mode, hydrogen stored in metal hydride storage tank 22 is directed to fuel cell power module 40. Fuel cell stack 42 of fuel cell power module 40 receives this hydrogen, as well as oxygen (e.g. from ambient air) as inputs, and through a fuel cell reaction, generates electricity and water. This operating process will now be described in further detail with reference to FIG. 2.

Referring to FIG. 2, a flow chart illustrating steps in the operating process of the embodiment of the mobile power supply system 10 shown in FIG. 1 is shown generally as 50.

At step 52, a vehicle propulsion unit (“prime mover”) provides electric power to electrolyzer module 30, usually via an alternator or similar device. For example, a vehicle alternator may supply about 28 VDC output to electrolyzer module 30. This step typically will be performed during the hydrogen generation mode, in which fuel cell power module 40 is inactive.

At step 54, electrolyzer stack 32 of electrolyzer module 30 consumes electricity provided at step 52 and water from a water source (e.g. a water reservoir) to produce hydrogen and oxygen gases in the hydrogen generation mode. The hydrogen gas produced can subsequently be dried in electrolyzer module 30.

In one implementation of this embodiment of the invention, electrolyzer stack 32 comprises 15 PEM electrolyzer cells and operates at about 26-28 VDC, about 130-140 A, and about 65-80° C. However, it will be understood by persons skilled in the art that electrolyzer stack 32 may operate with different operating parameters, and that alternative numbers, configurations and types of electrolyzer cells may be used in variant implementations of the invention.

For instance, the number of electrolyzer cells and active area of electrolyzer stack 32 can be sized to match the operating voltage and current of the vehicle alternator in any particular implementation of an embodiment of the present invention. In the specific example implementation described herein, system 10 is adapted for use on a military vehicle, which has a 28 V 200 A alternator and a 28 V battery. The number of electrolyzer cells in electrolyzer stack 32 and the active area of the electrolyzer cells are chosen so that the electrolyzer current consumption (and hence hydrogen gas generation) is limited to 140 A when electrolyzer stack 32 operates at 28 V and 65° C. In this way, electrolyzer stack 32 can be directly connected to the vehicle alternator without the need for additional power electronics. In addition, by raising or lowering the operating temperature of electrolyzer stack 32, control module 12 of system 10 is able to maintain the same current consumption even when there is variation in the supplied electrolyzer stack voltage which may occur during vehicle operation, particularly during engine warm-up. This same temperature control mechanism is also used to maintain the same current consumption through the life of electrolyzer stack 32 despite gradual performance degradation, as explained in further detail below.

In the hydrogen generation mode, hydrogen gas produced by electrolyzer module 30 (e.g. 10 m³ of dry hydrogen gas at 12 slpm, 100 psig) is directed to storage module 20. Oxygen gas produced can be vented to the ambient air, or may be applied or stored for other uses (e.g. as a source of oxygen in chemical biological nuclear (CBN) vehicles).

At step 56, hydrogen gas directed to storage module 20 is stored in metal hydride storage tank 22 in the hydrogen generation mode. Metal hydride storage tank 22 (e.g. 10 m³, 125 kg) contains a metal hydride to store the hydrogen gas (e.g. at 130 psig). Alternatively, the hydrogen gas can be stored directly in gaseous or liquid form in a different container, such as a pressurized tank, for example.

Metal hydride storage tank 22 is also appropriately sized for system 10. Since metal hydrides require heat to desorb the hydrogen from the metal matrix, system 10 is designed to produce enough heat to ensure that the required flow rate of hydrogen is provided to fuel cell power module 40 for continuous full power operation. In one embodiment of the invention, the heat is provided by circulating the coolant water for fuel cell stack 42 through a water jacket surrounding the metal hydride storage cylinders. As a result, metal hydride storage tank 22 is appropriately sized so that the waste heat generated by fuel cell power module 40 is sufficient to desorb required hydrogen (e.g. at step 58) at the required flow rate to fuel cell stack 42. These design consideration may include, for example, the storage capacity of the metal hydride cylinders, the metal hydride storage pressure, the heat exchange efficiency of the water jacket surrounding the metal hydride cylinders, the heat capacity of the overall system (as this can have an important effect during system transients), etc.

In variant embodiments of the invention, different configurations of water circulation systems that do not employ water jacket may be used for coupling to metal hydride storage tank 22. For instance, an internal cooling loop (e.g. using coils) that runs through the metal hydride cylinders of metal hydride storage tank 22 may be implemented.

Likewise, metal hydride storage tank 22 must be properly sized so that the metal hydrides are not forced to absorb hydrogen (e.g. at step 56) at too fast a rate such that they will be unable to dissipate the generated heat. Similarly, a heat exchange system used to provide heat during the electricity generation process in which hydrogen is discharged is also sufficiently sized to dissipate excess heat during the hydrogen generation process in which hydrogen is stored in metal hydride storage tank 22 (“charging”).

At step 58, hydrogen is released from metal hydride storage tank 22 of storage module 20 and directed to fuel cell power module 40 for the generation of electric energy in electricity generation mode. Fuel cell power module 40 comprises a fuel cell stack 42 that consumes the hydrogen as well as oxygen (e.g. from ambient air, or another oxygen source) to generate electricity and water.

In one implementation of this embodiment of the invention, fuel cell stack 42 comprises 33 PEM fuel cells, operates at about 20-33 VDC and a maximum current of about 250 A, and consumes up to 60 slpm of hydrogen gas to produce about 3-5 kW of electrical power. However, it will be understood by persons skilled in the art that fuel cell stack 42 may operate with different operating parameters, and that alternative numbers, configurations and types of fuel cells may be used in variant implementations of the invention.

For instance, in this example implementation where system 10 is adapted for use on a military vehicle, fuel cell stack 42 is sized so that the output voltage ranges from about 28 VDC (when the fuel cell stack 42 is powering only the system auxiliaries) to 24 VDC (when the system is at maximum output), enabling fuel cell stack 42 to be directly connected to the vehicle's power system (e.g. to charge the vehicle's batteries and supply power to the onboard system) without the need for additional power electronics.

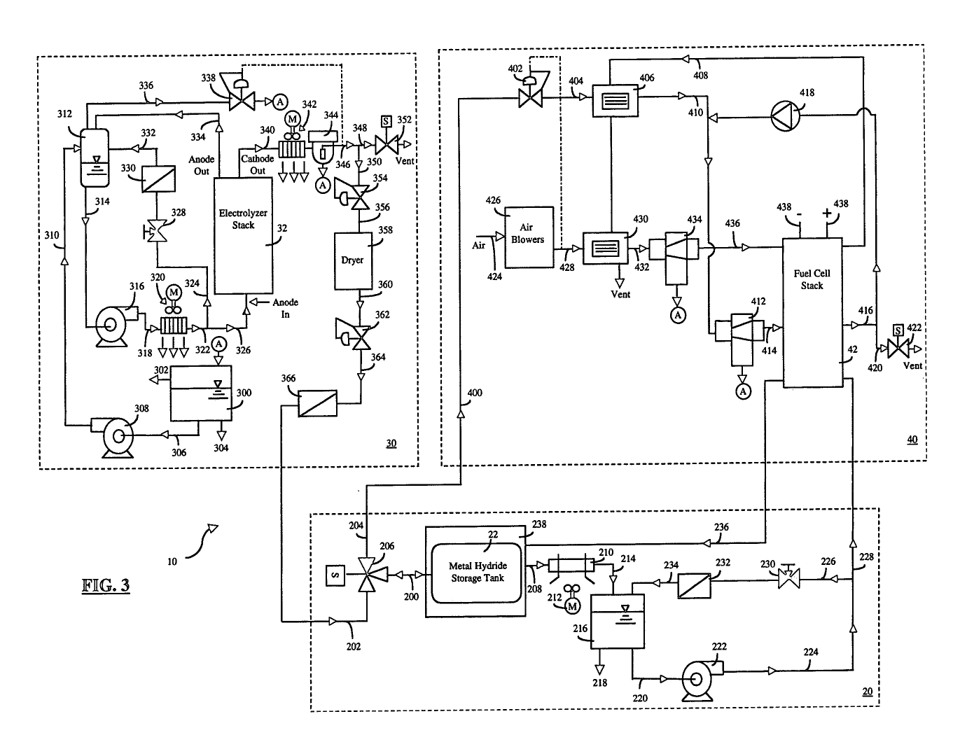

While FIGS. 1 and 2 illustrate the components of system 10 and the processes in which system 10 generates hydrogen and electricity in an embodiment of the invention, further novel and inventive features of system 10 will now be described in greater detail with reference to FIG. 3.

Referring to FIG. 3, a schematic diagram illustrating the components of the modules of the embodiment of the mobile power supply system 10 shown in FIG. 1 in further detail is shown.

### Storage Module

In this embodiment of the invention, storage module 20 comprises metal hydride storage tank 22 for storing hydrogen gas generated by electrolyzer module 30 in the hydrogen generation mode of system 10. Stored hydrogen may then be subsequently used by fuel cell power module 40 in the electricity generation mode of system 10. Hydrogen gas from electrolyzer module 30 is received by metal hydride storage tank 22 through lines 200 and 202 in the hydrogen generation mode, while hydrogen gas is transferred out of metal hydride storage tank 22 through lines 200 and 204 in the electricity generation mode. The flow of hydrogen gas during both operating modes is controlled by the switching of a three-way valve 206.

Sensors [not shown] coupled to metal hydride storage tank 22 are used to assist control module 12 of system 10 in detecting when metal hydride storage tank 22 is full. When a full condition is detected, control module 12 is programmed to shut down the operation of electrolyzer module 30, and provide an indicator to operators of system 10 that metal hydride storage tank 22 is fully charged.

In the hydrogen generation mode, metal hydride storage tank 22 heats up as it is filled with hydrogen gas from electrolyzer module 30. As metal hydride storage tank 22 heats up, the rate at which it can accept additional hydrogen diminishes. In order to maintain an optimal efficiency, metal hydride storage tank 22 is cooled in the hydrogen generation mode.

To achieve cooling of metal hydride storage tank 22, metal hydride storage tank 22 is coupled to a water circulation system (also referred to herein as “fluid cooling loop”) that facilitates the cooling. In the water circulation system, water used to cool metal hydride storage tank 22 flows through line 208 and through a cooler comprised of a main radiator 210 and associated fan motor 212 (e.g. 24 VDC, 100 W). In the hydrogen generation mode of system 10, cooling elements 210, 212 are always active so that metal hydride storage tank 22 may be kept as cold as possible.

Cooled water flows through line 214 to a fill tank 216 having a drain 218 that can be activated to control the level of water in fill tank 216. Water from tank 216 exits at line 220 and is pumped by a coolant pump 222 (e.g. 24 VDC, 200 W) out to line 224 (e.g. at 20 slpm, 6 psig, 60° C.) of a cooling loop.

Water at line 224 may be diverted partially to line 226 (e.g. at 1 slpm, 6 psig, 60° C.), while the balance is directed to fuel cell stack 42 through line 228. The amount of water diverted to line 226 is controlled by a valve 230, which recycles water through a mixed bed de-ionizing and carbon filter 232 and back to tank 216 through line 234. Filter 232 is used to gradually clean the water cycling through system 10, by removing ions (e.g. iron, chlorine, and copper ions) that may have accumulated in the water. Other ionic filters or methods of cleaning may be employed in variant implementations of the invention.

Water in line 228 travels through fuel cell stack 42 (which is inactive during hydrogen generation mode), and back to cool metal hydride storage tank 22 through line 236.

Although cooling elements 210, 212 act to cool the water circulating through the fluid cooling loop, the temperature of the water will still rise due to the heat generated by the metal hydrides as metal hydride storage tank 22 is filled with hydrogen. Accordingly, during hydrogen generation, waste heat produced by metal hydride storage tank 22 (and electrolyzer module 30) of system 10 can therefore be used to pre-heat fuel cell stack 42. This typically will result in a shortening of the start-up time necessary when switching system 10 to the electricity generation mode. This water circulation system can be tied to a vehicle's heat exchange system by a simple heat exchanger, thus extending the symbiotic benefits of pre-heating and consolidated heat exchangers to the vehicle's internal combustion engine system.

For example, if system 10 is “off”, it may be necessary to realize a “cold” start when powering on system 10 if it has been off for a certain period of time. In this scenario, both metal hydride storage tank 22 and fuel cell stack 42 will typically be at the same temperature. If the system 10 is initially set to run in hydrogen generation mode, during charging, the metal hydrides will release heat into the water of the fluid cooling loop. This heat can be used to warm the fuel cell stack 42, typically to temperatures above ambient, and shorten the subsequent start-up time of fuel cell stack 42.

Referring again to FIG. 3, in the electricity generation mode, water will flow through the water circulation system in a manner similar to that described above (i.e. water circulates through the water circulation elements of storage module 20 in both hydrogen and electricity generation modes). However, in the electricity generation mode, the water circulation system is not used to cool metal hydride storage tank 22. On the contrary, it is preferable to have metal hydride storage tank 22 as warm as possible in the electricity generation mode, to facilitate the more efficient release of hydrogen from metal hydride storage tank 22. The endothermic reaction of the metal hydrides releasing hydrogen is promoted by added heat. Put another way, it is important to warm the metal hydrides as the higher their temperature, the higher the release rate of hydrogen will be.

Accordingly, cooling elements 210, 212 will only be active to maintain a desired operating temperature in the fuel cell (e.g. about 65° C.). When cooling elements 210, 212 are inactive, heat generated from fuel cell stack 42 will heat the incoming water in line 228, to produce warmed water at line 236 for circulation back to warm metal hydride storage tank 22. This provides for a more efficient reuse of energy, as heat produced by fuel cell stack 42 is used to warm metal hydride storage tank 22, eliminating the need for separate warming means and thus potentially reducing the overall size and weight of system 10.

This also reduces the need for a large, additional heat exchanger to facilitate the dissipation of heat produced by fuel cell stack 42, thereby also potentially reducing the overall size and weight of system 10. For example, any heat exchanger and fan arrangement of an additional heat exchange subsystem that may be required to dissipate the remainder of the heat can be designed to be smaller or require a less powerful fan, thereby decreasing the size, mass, cost and electrical inefficiency of the additional heat exchange subsystem.

Furthermore, this arrangement will typically result in system 10 dissipating less heat to the local environment during system operation. Waste heat produced by fuel cell stack 42 which may be a potential problem in certain applications (e.g. some military or indoor applications) is instead reused in system 10.

In one embodiment of the invention, the water circulation system interfaces to metal hydride storage tank 22 through a water jacket 238 that partially surrounds the metal hydride storage tank 22. In the electricity generation mode, heat produced by fuel cell stack 42 is transferred through water jacket 238 to the metal hydride storage tank 22 via coolant water in the water circulation system. Water jacket 238 serves as a combined coolant expansion tank, coolant reservoir tank and coolant settling tank (for gas phase separation); water jacket 238 is large enough so that the flow of water through it slows down to allow any gas dissolved in the water to separate out, and to provide sufficient volume to allow for any expansion of the water when system 10 gets hot.

As indicated earlier, in variant embodiments of the invention, different configurations of water circulation systems that do not employ water jacket may be used for coupling to metal hydride storage tank 22. For instance, an internal cooling loop (e.g. using coils) that runs through the metal hydride cylinders of metal hydride storage tank 22 may be implemented.

### Electrolyzer Module

Electrolyzer stack 32 of electrolyzer module 30 consumes electricity and water to produce hydrogen gas and oxygen gas in the hydrogen generation mode. Typically, fuel cell power module 40 will be inactive during hydrogen generation mode.

Water tank 300 (e.g. a 50 L de-ionized water tank) is used to store water (e.g. at atmospheric pressure) for use in electrolyzer module 30. Tank 300 is equipped with a vent 302, through which gases may escape and through which water in tank 300 may overflow. Tank 300 is also equipped with a drain 304 through which excess water from tank 300 can be drained.

Water from tank 300 is directed through line 306 by pump 308 to line 310, and enters pressurized tank 312 for storage (e.g. at about 100 psig). In operation, pump 308 only pumps water from tank 300 to pressurized tank 312 when the level of water in pressurized tank 312 is too low. As water needs to be available to electrolyzer stack 32 in order to generate hydrogen, the level of water in pressurized tank 312 must be controlled. Level detectors [not shown] coupled to pressurized tank 312 are used to monitor the level of water therein.

Pressurized tank 312 is a special vessel that facilitates the separation of oxygen from water. The water level in pressurized tank 312 is monitored and controlled so that the combined volume of free space in pressurized tank 312 and the total pressurized oxygen gas volume in various lines of system 10 (i.e. up to valve 338 as in FIG. 3) occupies no more than one-half of the total volume of pressurized hydrogen gas in various lines of system 10 up back the pressure control valve adjacent to the output at the cathode of electrolyzer stack 32 (e.g. valve 354), to better ensure that the pressures at the outputs of electrolyzer stack 32 remain approximately equal. This helps to prevent damage to the cells of electrolyzer stack 32.

Water is pumped from pressurized tank 312 through line 314 by a cooling water circulation pump 316 (e.g. 24 W), which operates to control the flow of water through the electrolyzer stack 32 and/or back to pressurized tank 312 at a desired pressure.

In one embodiment of the invention, pump 316 is a centrifugal pump designed to deliver the optimal required water flow rate to electrolyzer stack 32 at the rated system hydrogen production (which corresponds to the maximum back pressure on the anode (water and oxygen) side of electrolyzer stack 32). Variable back pressure generated on the anode side of electrolyzer stack 32 (e.g. as caused by an increase in oxygen generation as electrolyzer stack 32 warms up to its standard operating temperature) can cause variations in the water flow rate through electrolyzer stack 32.

Accordingly, the use of a centrifugal pump (e.g. in contrast to positive displacement pumps) prevents over-pressurization of the anode side of electrolyzer stack 32 and the creation of differential pressure problems, because the centrifugal pump is designed to not exceed a differential pressure limit (determined through operational experience), even with complete flow blockage. Centrifugal pumps have clearance between the impeller blades of the pump and the pump housing. Because there is a space between the impeller blades and the pump housing, water is able to flow through the pump even then the pump is not running. Likewise, because of this clearance, centrifugal pumps are only able to generate a relatively small pump head pressure. In addition, the water flow rate of a centrifugal pump depends on the back pressure: the higher the back pressure, the lower the water flow rate, until the pump stalls out and the water actually stops flowing out of the pump.

Furthermore, through proper sizing of pump 316 such that the pressure differential rating is never exceeded (i.e. pump 316 can operate only up to a maximum discharge pressure designed not to exceed the maximum anode-to-cathode differential pressure), pressure spikes that could damage electrolyzer stack 32 (e.g. which may be caused by a sudden evolution of oxygen at the anode, particularly when power is first applied to electrolyzer stack 32 and the generated oxygen must displace the water which is completely filling the anode side of electrolyzer stack 32) are avoided. In additional to providing the optimal water flow required for operation of electrolyzer stack 32, the water flow rate through electrolyzer stack 32 is sufficient to act as the coolant for electrolyzer stack 32 at the maximum hydrogen production rate. At lower hydrogen production rates, the back pressure on the anode side of electrolyzer stack 32 is decreased and more water flows through the electrolyzer stack 32, however, because of the operational nature of centrifugal pumps (increased back pressure results in decreased water flow and vice versa), the differential rating of electrolyzer stack 32 is not exceeded.

Moreover, the use of a centrifugal pump generally offers longer pump life (e.g. resulting from lack of friction between the impeller and pump housing) and requires less frequent maintenance. Also, a separate speed controller or flow controller is not required for pump 316 as it can be turned on to full power during the operation of electrolyzer stack 32, as opposed to a positive displacement pump, which would need an additional speed controller for example, to prevent over-pressurizing electrolyzer stack 32 when power is first applied to electrolyzer stack 32.

While a centrifugal pump is employed as pump 316 in one embodiment of the present invention, other pumps that are not positive displacement pumps may be used in variant embodiments of the invention.

Referring again to FIG. 3, pump 316 directs water through line 318 to a heat exchanger or cooler 320 (e.g. a Thermotron® 730 24 V fan) which cools the water, if required, before it enters electrolyzer stack 32. The temperature of the water entering electrolyzer stack 32 has a direct effect on the overall temperature of electrolyzer stack 32. Data obtained from a temperature sensor (e.g. hall effect type sensor) [not shown] coupled to electrolyzer stack 32 is used to control the operation of cooler 320. When cooler 320 is inactive, the temperature of electrolyzer stack 32 will rise, and when cooler 320 is made active, the temperature of electrolyzer stack 32 can be suppressed.

Cooler 320 is operable to control the temperature of the water entering electrolyzer stack 32 for a number of reasons. First, by controlling the temperature of the water, the temperature of electrolyzer stack 32 can be controlled to prevent overheating. Cooler 320 is used to ensure that the water is cooled sufficiently to prevent electrolyzer stack 32 from attaining a temperature greater than a defined maximum operating threshold.

Second, cooler 320 is also used to vary the amount of current drawn by electrolyzer stack 32. Data obtained from a current sensor [not shown] coupled to electrolyzer stack 32 can be used to determine whether cooler 320 should be activated. By raising the temperature of the water entering electrolyzer stack 32 (but up to a certain threshold so as not to cause electrolyzer stack 32 to overheat) the temperature of electrolyzer stack 32 will be raised, causing more current to be drawn at the same operating voltage of electrolyzer stack 32, and accordingly, the amount of hydrogen generated to increase. Conversely, if the operating temperature of electrolyzer stack 32 is lowered by lowering the temperature of the water, the rate of current consumption, and accordingly, the rate of hydrogen production is decreased for the same operating voltage.

By controlling the stack temperature to, in turn, control the current consumption of electrolyzer stack 32 (and therefore also hydrogen production, since the amount of hydrogen produced is a function of the current consumed), this aspect of the present invention provides for a number of significant additional advantages over prior art regenerative fuel cell systems. For example, control of the output of electrolyzer stack 32 in this manner makes it possible to ensure that the power drawn by electrolyzer stack 32 is not more than the electric power supply coupled to it can deliver.

Furthermore, this aspect of the present invention also allows a constant rate of hydrogen production to be maintained throughout the life of electrolyzer stack 32, in contrast to known systems in which the rate of hydrogen production may decrease over the life of their respective electrolyzer stacks. The present invention allows a constant rate of hydrogen production to be maintained throughout the life of electrolyzer stack 32 without varying the voltage of electrolyzer stack 32; the increase in temperature offsets the decay in electrolyzer performance so that the current draw, and hence, hydrogen production, remains consistent throughout the life of electrolyzer stack 32.

This aspect of the present invention also eliminates the need for expensive, heavy, or large power electronics to gradually increase the voltage of electrolyzer stack 32 over its life to maintain the same hydrogen production rate, which would otherwise add additional cost, size, and weight to system 10. The invention provides for a relatively simple system with fewer potential failure modes compared to complicated power electronics.

Moreover, this aspect of the present invention permits electrolyzer stack 32 to continue to operate at the same electrical efficiency throughout its life, since the voltage of the electrolyzer stack 32 need not be increased to compensate for any degradation in performance. This aspect of the present invention also permits electrolyzer module 30 to accommodate for variations in an electrical power supply voltage supplied to electrolyzer stack 32; the operating temperature of electrolyzer stack 32 can either be raised or lowered so that the same rates of hydrogen production and current draw will occur even if the supplied supply voltage is consistently higher or lower than a standard operating voltage.

Referring again to FIG. 3, water exiting cooler 320 may be diverted partially to line 324, while the balance is pumped to electrolyzer stack 32 through line 326 (e.g. at 3-6 slpm, 100 psig, 65° C.). The amount of water diverted to line 324 is controlled by a valve 328, which recycles water through a mixed bed de-ionizing and carbon filter 330 and back to pressurized tank 312 through line 332. Filter 330 is used to gradually clean the water cycling through system 10, by removing ions (e.g. iron, chlorine, and copper ions) that may have accumulated in the water. Other ionic filters or methods of cleaning may be employed in variant embodiments of the invention.

Water enters through line 326 to the anode of electrolyzer stack 32, which converts electricity received from a power source [not shown] and the water to hydrogen and oxygen gases.

Gas containing the oxygen (and residual water) exits from the anode of electrolyzer stack 32, and is directed through line 334 to pressurized tank 312. The gas containing oxygen is separated from the water in pressurized tank 312, and is pushed through line 336 (e.g. at 3-6 slpm, 100 psig, 40° C. max) to a dome loading backward pressure regulator 338, which controls the venting of the gas. The gas to be vented may be redirected to tank 300 (as indicated by the A symbols in FIG. 3) to recover any residual water vapour in the gas, or alternatively, the gas can be vented directly to ambient air, or otherwise stored or applied as desired.

Regulator 338 allows line 336 to fill with oxygen-containing gas until a desired pressure (e.g. 100 psig) is reached. Regulator 338 is coupled to a line containing hydrogen gas from which the dome load signal is obtained, such that regulator 338 opens (thereby venting the oxygen-containing gas) when its back pressure is greater than the dome load pressure in the line containing hydrogen gas. This aspect of the present invention will be described in further detail below.

Referring again to FIG. 3, while gas containing oxygen exits from the anode of electrolyzer stack 32, gas containing hydrogen exits from the cathode of electrolyzer stack 32 at line 340. Safety pressure sensors and pressure valves may be coupled to lines 334 (at the anode) and 340 (at the cathode), which operate to monitor the difference in pressures between these two outputs and help system 10 to maintain them at an approximately equal level to prevent damage to electrolyzer stack 32. The gas containing hydrogen is directed through line 340 to a cooler 342 (e.g. a Thermotron® 730 24 V fan), which operates to knock out water from the gas, which facilitates drying of the hydrogen gas before storage.

Output of cooler 342 is directed to a separator 344, which directs hydrogen gas to line 346 while diverting liquid water back to tank 300 (as indicated by the A symbols in FIG. 3) for reuse. Separator 344 is coupled to a valve and water level detectors [not shown] to maintain enough water in separator 344 to prevent hydrogen gas from being diverted to tank 300.

In one implementation of an embodiment of the present invention, the pressure at line 346 is maintained at 100 psig during normal operation of system 10 in the hydrogen generation mode. In this implementation, water knocked out by separator 344 easily travels back to tank 300, since line 346 is at 100 psig while tank 300 is at atmospheric pressure. The recovery of water within electrolyzer module 30, and overall within system 10, increases the water neutrality of system 10. Water neutrality means that no water will ever have to be added to the system. For example, if the water generated by fuel cell module 40 could be completely captured (existing water is knocked out, cooling of the fuel cell exhaust stream (vent lines) so that all water in the vapor phase is condensed and captured as liquid water), that water could be recycled back to tank 300 to be used later by electrolyzer module 30 to generate hydrogen and oxygen. If all of the water generated from the fuel cell stack could be captured, a closed loop system with water neutrality could be implemented, where no additional makeup water needs to be added to storage tank 300. Practically, however, systems are not 100% efficient. Nevertheless, by removing water from the hydrogen stream in electrolyzer module 30 and returning it to tank 300 to be reused, water neutrality of system 10 can at least be increased.

Regulator 338 is coupled to line 346, such that the opening and closing of regulator 338 is determined from the difference between pressures at lines 336 and 346. As indicated earlier, regulator 338 opens when its back pressure is greater than the dome load pressure at line 346. While line 346 could be positioned before cooler 342 and separator 344 in variant implementations, utilizing the dome load pressure at line 346 positioned after cooler 342 and separator 344 provides the benefit of minimizing the amount of water that might be entrained in the gas control line which dome loads regulator 338. In this example implementation, when the pressure at line 346 is 100 psig, regulator 338 does not vent oxygen until the pressure at line 336 is also 100 psig. If the pressure at line 336 increases above 100 psig, regulator 338 opens to allow oxygen to vent until the pressure decreases back to 100 psig, at which time regulator 338 closes. Accordingly, regulator 338 provides a simple means for controlling the venting of oxygen gas.

Furthermore, in order to prevent damage to electrolyzer stack 32 (e.g. by rupturing the membranes therein), there is a need to control the differential pressure between the anode and cathode side of the membranes therein, and to ensure that no differential pressure situations arise during operation of system 10. For example, these situations may arise during startup of electrolyzer module 30 (or of system 10), shutdown of electrolyzer module 30 (or of system 10), and normal operation of electrolyzer module 30, and may include situations arising from the metal hydride storage tank 22 being full, or from pressure changes resulting in the operation of other components of electrolyzer module 30 (e.g. dryer).

Accordingly, since regulator 338 attempts to maintain roughly equal pressures at lines 336 and 346, regulator 338 also provides a simple means to control the relative pressures at the outputs of electrolyzer stack 32 (in this example implementation, at the anode and cathode respectively) during operation of electrolyzer module 30. In actual operation of one implementation of the invention, the oxygen gas pressure will generally follow the hydrogen gas pressure during the hydrogen generation process, with the oxygen pressure being about 1 psig higher than the hydrogen pressure. However, the pressure balance could have one of either hydrogen or oxygen being slightly higher than the other in variant implementations.

In this implementation as described in FIG. 3, input to regulator 338 originates from the anode of electrolyzer stack 32 with the dome load signal originating from the cathode of electrolyzer stack 32; however, in variant implementations, electrolyzer module 30 may be reconfigured to employ a reversed arrangement.

Moreover, by employing a passive tracking control means, no separate pressure control scheme is required. The use of a mechanical pressure tracking system greatly simplifies system complexity, and eliminates the need for an electronic pressure control scheme that may be expensive, require access to a source of system power for control, pose potential added maintenance problems, and require configuration to account for different situations that can arise during operation of system 10. This aspect of the present invention is not prone to electronics tuning issues or power failures which could otherwise cause differential pressure spikes between the anode and cathode sides of electrolyzer stack 32 and cause permanent damage.

The present invention also facilitates a rapid transient pressure response; since the back pressure of the anode side of electrolyzer stack 32 is directly controlled by the pressure of the cathode side of electrolyzer stack 32, no differential pressure issues arise during startup or shutdown of electrolyzer module 30 (or of system 10), when there can be rapid pressure increases or decreases within electrolyzer module 30.

Accordingly, this aspect of the present invention provides for an arrangement for pressure-following, such that either the pressure of the generated oxygen follows the pressure of the generated hydrogen, or vice-versa, in an electrolyzer module 30 of a regenerative fuel cell system 10. The pressure following function may be provided by, for example, a negative dome loading pressure valve, a positive dome loading pressure valve, current-to-pressure devices, or electronically actuated regulators in variant embodiments of the invention. However, as indicated above, the use of a mechanical regulator that does not rely on electronics to control the pressure differential across electrolyzer stack 32 permits the differential pressure across electrolyzer stack 32 to be maintained at a safe value even while system 10 discharges when system 10 is powered off.

Referring again to FIG. 3, the hydrogen-containing gas in line 346 can be diverted to lines 348 or 350, depending on whether or not valve 352 is open or closed. Valve 352 can be opened in order to vent the hydrogen-containing gas in electrolyzer module 30 (e.g. when electrolyzer module 30 is to be shut down upon switching to an electricity generation mode). Valve 352 controls the rate at which the gas is vented from electrolyzer module 30, and is designed to permit the gas to vent gradually to protect the components of electrolyzer module 30. As described above, the venting of hydrogen-containing gas through valve 352 will cause a decrease in the pressure at line 346, which in turn will automatically cause the oxygen-containing gas in line 336 to gradually vent through regulator 338. This provides a simple means to ensure that the relative pressures across the outputs of electrolyzer stack 32 are controlled during the shut down of electrolyzer module 30, to prevent damage to electrolyzer stack 32. Controlling the rate of de-pressurization better ensures not only that regulator 338 will operate to accurately track the cathode back pressure (at line 346) to ensure that a damaging differential pressure across electrolyzer stack 32 is not created, but also that pumps of electrolyzer module 30 (e.g. pump 316) will not deprime and hinder a restart of system 10.

In normal operation of system 10 during hydrogen generation mode, however, the hydrogen-containing gas will be directed through line 350 (e.g. at 6-12 slpm, 100 psig, 40° C. max) to a pre-dryer back pressure control valve 354, which is fixed or manually set to maintain the pressure in lines 346 and 350 at a desired operating pressure (e.g. 100 psig), while excess gas is released to line 356 to be dried in dryer 358. The presence of valve 354 ensures that pressure fluctuations that may occur during the operation of dryer 358 will not result in pressure fluctuations at the cathode of electrolyzer stack 32.

The position of valve 354 in electrolyzer module 30 can have an effect on the sizing and placement of various components of electrolyzer module 30, and also on the control of the desired water level in pressurized tank 312. As indicated earlier, the water level in pressurized tank 312 is monitored and controlled so that the combined volume of free space in pressurized tank 312 and the total pressurized oxygen gas volume in various lines of system 10 up to valve 338 occupies no more than one-half of the total volume of pressurized hydrogen gas in various lines of system 10 up back the pressure control valve adjacent to the output at the cathode of electrolyzer stack 32 (e.g. valve 354). Reasons for maintaining this water level relate to the nature of hydrogen and oxygen production by electrolyzer stack 32.

In the electrolysis reaction, two molecules of hydrogen gas are generated for every molecule of oxygen gas produced (this relates back to the ratio of H to O in H₂O). Because hydrogen is generated twice as quickly as oxygen, care is taken in sizing the volume of electrolyzer module 30 so that the hydrogen pressure does not build quicker than the oxygen pressure, thus causing a destructive pressure differential across the membranes of electrolyzer stack 32. Because the back pressure of the hydrogen is controlled by a fixed back pressure regulator 354 set to 100 psig as shown in this example implementation, the pressure on the hydrogen side of electrolyzer stack 32 in electrolyzer module 30 will build up regardless of what the pressure is on the oxygen side of electrolyzer stack 32 in electrolyzer module 30. The pressure on the oxygen side is controlled by dome loading back pressure regulator 338 which gets its dome load control signal (actually a gas pressure) from the hydrogen side. As a result, the oxygen pressure can only build as quickly as the increasing pressure on the hydrogen side. However, because twice as much hydrogen gas is produced as oxygen, if the volumes of components of electrolyzer module 30 are not sized properly, the hydrogen pressure could build up to twice as fast as the oxygen pressure. Regulator 338 would try to track the pressure on the hydrogen side, but not enough oxygen would be generated to increase the pressure on the oxygen side quickly enough, resulting in a destructive pressure differential across the membranes of electrolyzer stack 32.

To ensure that this does not happen, the pressurized hydrogen gas volume in lines of electrolyzer module 30 up to regulator 354 must be at least twice the pressurized gas volume on the oxygen side (to minimize the overall volume of the system, components of electrolyzer module 30 may be accordingly sized to keep the volume ratio closer to 2). In this way, the hydrogen pressure is not physically able to build faster than the oxygen pressure. Since the pressure on the oxygen side is controlled by regulator 338, even if the oxygen gas volume on the oxygen side is less than half the volume of the hydrogen side, the oxygen side will not cause an overpressure as regulator 338 operates to track the hydrogen pressure on the hydrogen side.

Referring again to FIG. 3, dryer 358 is used to remove moisture from the hydrogen-containing gas received at line 356 before the hydrogen is to be stored. In particular, where metal hydrides are used in storage module 20 to store hydrogen, the presence of impurities, including water, in hydrogen-containing gas to be stored will have an adverse effect on the efficiency of the storage mechanism used. Therefore, removing excess water from the hydrogen-containing gas before storage will typically improve the operation of system 10.

In one implementation of an embodiment of the present invention, dryer 358 is a pressure swing absorption dryer, which will generate dry hydrogen as output at line 360, and which may vent a certain amount of water and hydrogen during operation [vent not shown]. It will be understood by persons skilled in the art that drying means other than a pressure swing absorption dryer may be employed in variant embodiments of the invention.

In variant embodiments of the invention, electrolyzer module 30 may also be configured to permit hydrogen gas stored in storage module 20 to be passed through the desiccant of a dryer, to facilitate drying of the desiccant and remove water from the dryer (by moistening the hydrogen) when the electrolyzer module is inactive.

Dry hydrogen gas at line 360 (e.g. at 10.8 slpm, 95 psig) is directed to storage module 20 through a back pressure regulator 362 (e.g. to maintain the backward pressure at 95 psig), and optionally through one or more filters such as safety filter 366, which further filters out undesired components (e.g. oxygen, moisture, etc.) before storage of the hydrogen. Regulator 362 operates in conjunction with regulator 354 to isolate pressure fluctuations or spikes in the dryer 358 from other components of the electrolyzer module 30, which would occur during switches in a pressure swing absorption dryer, for example.

Regulator 362 also ensures that a constant supply pressure is provided to storage module 20 as hydrogen is generated for storage, so that pressure fluctuations in the operation of dryer 358 are isolated from storage module 20.

Additional moisture sensors or other components [not shown] may be used to detect the quality of the hydrogen gas generated by dryer 358, and vents [not shown] may be employed to exhaust hydrogen gas from electrolyzer module 30 if the gas is considered to be unfit for storage. For example, electrolyzer module 30 may also comprise a dewpoint meter and associated valve [not shown] after filter 366, which operate to vent the hydrogen if the dewpoint is above a set value and to otherwise direct the hydrogen to storage module 20 for storage.

Dry hydrogen gas directed to storage module 20 is then stored in metal hydride storage tank 22. Metal hydride hydrogen storage media must generally be pressurized to achieve its maximum level hydrogen storage equilibrium. Accordingly, the operating or discharge pressure of electrolyzer stack 32 is matched to the pressure required for hydrogen drying and subsequent storage in metal hydrogen storage tank 22. This is determined at least in part by the material properties of the storage medium, which in this case comprises metal hydrides. The metal hydrides are in the form of a metallic powder which absorbs the most hydrogen at a pressure of about 100 psig. By utilizing the discharge pressure of electrolyzer stack 32 to facilitate the drying and storage of hydrogen, the added size, mass, cost and complexity of an additional hydrogen compressor is eliminated.

### Fuel Cell Power Module

Fuel cell stack 42 of fuel cell power module 40 consumes hydrogen and oxygen to generate electricity in a fuel cell reaction, and to produce water as a by-product of the reaction in the electricity generation mode. Typically, electrolyzer module 30 will be inactive during electricity generation mode.

Hydrogen gas is retrieved (e.g. at 60 slpm, 17.5 psig, 30° C.) from storage module 20 through line 400, aided by the internal pressure of metal hydride storage tank 22. The flow of hydrogen to fuel cell stack 42 is controlled by a bias dome loading forward pressure regulator 402 which can be fixed or manually set to maintain the pressure of the hydrogen flowing through line 404 to a desired pressure greater than the air inlet pressure (e.g. about 1 psig greater than the air inlet pressure in line 428 of FIG. 3 for instance). Since the pressure of hydrogen in storage module 20 decreases as the volume in storage module 20 is depleted, regulator 402 acts to ensure a consistent hydrogen supply pressure to fuel cell stack 42 while preventing damaging pressure spikes in storage module 20 from affecting the pressure at the inlet of fuel stack 42. More generally, regulator 402 will act to protect fuel stack 42 from damaging pressure differentials, which will be explained in greater detail below.

Hydrogen gas at line 404 is directed through a saturator unit 406, which humidifies the hydrogen gas, using the excess moist exhaust gas produced at the cathode of fuel cell stack 42 during the fuel cell reaction (e.g. at 248 slpm, 16 psig, 65° C., relative humidity 100%) and redirected to saturator unit 406 through line 408. The reuse of the exhaust gas eliminates the need for an additional humidification device to humidify the hydrogen gas, thereby potentially reducing the overall size and weight of system 10. Humidification of the process gases including hydrogen will typically increase the performance and life of fuel cell stack 42.

The moistened hydrogen gas is directed through line 410 (e.g. at 60 slpm, 17 psig, 65° C., relative humidity 75%) to an inline water separator 412, which ensures that the hydrogen gas stream does not contain liquid water. Any liquid water collected by separator 412 can either be drained from system 10 or collected for future electrolysis (e.g. to tank 300 as indicated by the A symbols in FIG. 3).

Hydrogen gas then enters at the anode of fuel cell stack 42 at line 414 to be used in the fuel cell reaction. Excess hydrogen is output from fuel cell stack 42 at line 416, and can be recirculated to the hydrogen stream at 410 by recirculation pump 418. This provides for less wasted hydrogen. Some excess hydrogen may also be diverted to line 420 to be vented as controlled by valve 422 (e.g. at 2% of max flow, 14.5 psig, <65° C.), to reduce the build up of undesirable elements (e.g. nitrogen gas) that may have been inadvertently introduced in the hydrogen stream.

While hydrogen gas is directed to fuel cell stack 42, oxygen gas will also be retrieved from a source of ambient air 424 (or other oxygen source, which may be stored, for example) for use by fuel cell stack 42. Oxygen-containing gas, i.e. air, in this implementation, from source 424 (e.g. at about 400 slpm max, atmospheric pressure, 4-30° C.) may be passed through one or more filters [not shown] to remove undesired elements in the air stream. The air is pushed through fuel cell power module 40 by air blowers 426 (e.g. a pair of 48 VDC, 270 W air blowers), which operate to control the flow of air, and to maintain a desired pressure. For example, air blowers 426 may maintain a flow of air at a pressure of about 1-3 psig, and this can vary dynamically depending on the load demand on fuel cell stack 42. Generally, an increase in current draw (e.g. as measure by a current sensor [not shown]) will result in an increase in the fan speed of air blower 426, in accordance with stoichiometric data determined empirically for system 10 as representing stable fuel cell stack operating stoichiometries. For instance, the stoichiometric mapping of the required air flow can depend on a number of factors such as the fuel cell stack current, the desired stoichiometry, the number of fuel cells in fuel cell stack 42, Avogadro's number, the molar mass of oxygen, the percentage of oxygen in air, and corrective factors for example.

Data obtained from a voltage monitor [not shown] coupled to fuel cell stack 42 can also be used in controlling the operation of air blowers 426. In addition to the stoichiometric mapping of the required air flow, a multicell voltage monitoring feedback device can be used to determine if additional air, above and beyond the estimated stoichiometric requirement, is required for stable operation of fuel cell stack 42. While the estimated stoichiometric values are mapped into control module 12, instability of fuel cell stack 42 during operation of fuel cell power module 40 may necessitate additional air flow for a short period of time to restore stability in fuel cell stack 42.

The output of air blowers 426 is provided at line 428 (e.g. at 350 slpm, 17.5 psig, 50° C., relative humidity 0.5%). The pressure at line 428 is used to control the operation of regulator 402. As explained above, regulator 402 ensures that the pressure of the hydrogen gas to be directed to the anode of fuel cell stack 42 is not too high, which could damage fuel cell stack 42. However, a difference in pressures at the anode and cathode of fuel cell stack 42 may also potentially damage the fuel cell stack 42, and particularly the membranes of PEM fuel cells where used in fuel cell stack 42. Therefore, regulator 402 retrieves its dome load signal from line 428, to ensure not only that the pressure of the hydrogen gas being directed to the anode of fuel cell stack 42 is not too high, but also that the pressure of the hydrogen gas does not exceed a set bias value greater than the pressure of the oxygen being directed to the cathode of fuel cell stack 42, which in this implementation, is approximately 1 psi.

Furthermore, by coupling regulator 402 to line 428 such that regulator 402 delivers hydrogen to fuel cell stack 42 at a rate dependent on the air inlet pressure at 428, this ensures that a sufficient amount of increased hydrogen is delivered when the air inlet pressure increases, as a result of an increased current draw from fuel cell stack 42 as described above, for example.

As indicated earlier with reference to regulator 402, regulator 402 in one embodiment of the invention is a bias dome loading forward pressure regulator. In variant embodiments of the invention, other types of valves may be used in system 10 including other forward pressure regulating valves, for example. However, there are some significant operational advantages to specifically using a bias dome loading forward pressure regulator.

For example, by dome loading the forward pressure regulator with the fuel cell cathode inlet pressure as the control signal, as the inlet air flow on the cathode is increased (which corresponds to an increase in current draw from fuel cell stack 42), the cathode inlet pressure increases. In turn, the hydrogen (anode) inlet pressure increases, which ensures that sufficient hydrogen is available for fuel cell stack 42 to consume at the higher load demand. Conversely, as the inlet air flow on the cathode is reduced (which corresponds to an decrease in current draw from fuel cell stack 42), the cathode inlet pressure is also reduced. In turn, the hydrogen (anode) inlet pressure is reduced, since a reduction in hydrogen consumption occurs with the reduction in load on the fuel cell stack 42. The bias dome loading pressure control of the hydrogen pressure ensures that fuel cell stack 42 never sees a differential anode to cathode pressure much greater than the bias setting on regulator 402.

If, on the other hand, a fixed forward pressure regulator were substituted for the bias dome loading forward pressure regulator, then the hydrogen inlet pressure setting would be set to the highest required anode inlet pressure to deliver sufficient hydrogen flow at full power draw from fuel cell power module 40. As a result, at low power draw, there would be a much larger pressure differential between the anode and the cathode of fuel cell stack 42, which would increase the leak rate of hydrogen from the anode to the cathode in fuel cell stack 42, thus increasing crossover leak rates and decreasing the life of fuel cell stack 42.

Referring again to FIG. 3, the oxygen-containing air at line 428 is directed through a saturator unit 430, which humidifies the inlet air stream using the excess moist exhaust gas produced at the cathode of fuel cell stack 42 during the fuel cell reaction. In the configuration of elements of fuel cell power module 40 as shown in FIG. 3, the exhaust gas humidifies the hydrogen stream first because a higher humidity level is targeted for the inlet hydrogen stream in this example implementation. The reuse of this exhaust gas eliminates the need for an additional humidification device to humidify the oxygen gas, thereby potentially reducing the overall size and weight of system 10. The excess exhaust gas is then vented.

The moistened oxygen-containing air is directed through line 432 to an inline water separator 434, which ensures that the oxygen-containing air to be used by fuel cell stack 42 does not contain any liquid water. The liquid water collected by separator 434 can either be drained from system 10 or collected for later electrolysis (e.g. to tank 300 as indicated by the A symbols in FIG. 3). The oxygen-containing air then enters at the cathode of fuel cell stack 42 at line 436 (e.g. at 350 slpm, 17 psig, 65° C., relative humidity 30%) to be used in the fuel cell reaction. Excess exhaust air or gas is output from fuel cell stack 42 at line 408, and can be circulated for reuse as described above, or vented.

In addition to collecting and recycling water from separators 412, 434, vent lines of fuel cell module 40 can be configured to collect and recycle additional water. For example, a portion of a vent line may be shaped with a bend, so that water will condense and collect at the bottom of the bend, which can then be retrieved by a pump to be collected for later electrolysis (e.g. to tank 300). Other additional devices may also be employed in both electrolyzer module 30 and fuel cell power module 40 to recycle excess water in various parts of system 10.

The fuel cell reaction in fuel cell stack 42 generates electricity, which can be drawn from terminals 438 of fuel cell stack 42. Heat generated from the fuel cell reaction is reused to heat the water in the water circulation system of storage module 20, as described above.

### Control Elements and Control Module

While not explicitly shown in FIG. 3, the operation of various elements of system 10 is monitored by control module 12. Furthermore, in addition to the sensors, valves, regulators, and other elements described above, it will be understood by persons skilled in the art that system 10 will comprise additional elements necessary to properly monitor and operate system 10.

For example, system 10 may employ additional water filters and water quality sensors at various stages of operation, which work to prevent damage to elements of system 10.

Water resistivity can be monitored within both electrolyzer module 30 and fuel cell power module 40, and control module 20 can be programmed to cease generation of hydrogen or electricity (depending on the operating mode) until a desired resistivity is attained.

Additional flow and level switches and flow and level sensors may be employed to prevent damage to or overflow in elements of system 10. Additional safety temperature and pressure (e.g. differential pressure) sensors, valves and switches that work to shut down power to one or more elements of system 10 under errant or undesired conditions may be employed. Alarm elements may also be employed to notify operators of system 10 of errant or undesired conditions. Other control elements may also be employed in variant embodiments of the invention.

Data from sensors may be received by control module 12, and displayed in a desired format to operators of system 10 (e.g. as “user feedback”) through a user interface. The organization of the data, and the manner of display is flexible and can be tailored to the specific requirements of the actual use or an operator's actual needs. Some examples of data that may be monitored and displayed to operators of system 10 may include:

| Hydrogen Generation Mode | Electricity Generation Mode |
|---|---|
| Electrolyzer stack voltage | Fuel cell stack voltage |
| Electrolyzer cell voltages | Fuel cell voltages |
| Electrolyzer current | Fuel cell stack current |
| Pressure across electrolyzer | Pressure across fuel cell stack |
| stack (i.e. anode/cathode | (i.e. anode/cathode pressure |
| pressure differential) | differential) |
| Anode outlet water temperature | Anode outlet temperature and |
| Anode pressure | pressure |
| Cathode gas temperature | Cathode outlet-to-humidifier |
| Cathode pressure | temperature |
| Water resisitivity | Cathode pressure |
| Metal hydride storage tank | Cathode metal hydride storage |
| pressure | tank-to-exhaust temperature |
| Metal hydride storage tank state | Water resistivity |
| of charge | Metal hydride storage tank |
| Hydrogen flow rate (a function of | pressure |
| electrolyzer current) | Metal hydride storage tank state |
| Other temperature and pressure | of charge |
| readings at various points in | Other temperature and pressure |
| system 10 as may be desired | readings at various points in |
| | system 10 as may be desired |

It will be understood by persons skilled in the art that the elements mentioned in the above table are provided by way of example only, and variant implementations incorporating the use or monitoring of fewer, greater, or different elements are not intended to be outside the scope of the present invention.

It will also be understood by persons skilled in the art that various operating parameters (e.g. temperature, pressure, flow, relative humidity) as provided in the present description of embodiments of the present invention are approximate, provided by way of example, and are representative of one particular implementation of an embodiment of the invention only. Such parameters may differ in variant implementations of the invention.

In variant embodiments of the invention, system 10 may also operate in additional operating modes. For example, system 10 may operate in a “service mode”, in which the operator of system 10 is given access only to a subset of system process parameters, which may otherwise not be made available to operators when system 10 runs normally in either the hydrogen generation mode or electricity generation mode. While in a “service mode”, system 10 may proceed to operate in either hydrogen generation mode or electricity generation mode as described herein.

The present invention has been described with reference to particular embodiments. However, it will be understood by persons skilled in the art that a number of other variations and modifications are possible without departing from the scope of the invention as defined in the appended claims.

1. A power supply system comprising:
a. a hydrogen storage module;
b. a fuel cell power module coupled to said hydrogen storage module, said fuel cell power module comprising at least one fuel cell having an anode and a cathode;
c. an electrolyzer module coupled to said hydrogen storage module, said electrolyzer module comprising at least one electrolyzer cell having an anode and a cathode; and
d. a control module coupled to said hydrogen storage, fuel cell power, and electrolyzer modules;
wherein said system is operable in at least a hydrogen generation mode where hydrogen gas is generated by said at least one electrolyzer cell received thereby for storage in said hydrogen storage module, and an electricity generation mode where hydrogen gas is retrieved from said hydrogen storage module and used by said at least one fuel cell unit to produce electric energy.

2. The system of claim 1, wherein said electrolyzer module comprises at least one temperature regulation device coupled to said at least one electrolyzer cell for varying the operating temperature of said at least one electrolyzer cell, such that the current draw of said at least one electrolyzer cell is controlled.

3. The system of claim 2, wherein said at least one temperature regulation device comprises a heat exchanger for varying the temperature of water entering said at least one electrolyzer cell.

4. The system of claim 2, wherein said at least one electrolyzer cell operates at a substantially constant operating voltage while said operating temperature thereof is varied, and wherein said operating temperature thereof is varied by said at least one temperature regulation device such that variations in said current draw is a function of variations in said operating temperature.

5. The system of claim 2, wherein said at least one electrolyzer cell operates at a varying operating voltage while said operating temperature is varied, and wherein said operating temperature thereof is varied by said at least one temperature regulation device such that said current draw is maintained substantially constant.

6. The system of claim 1, wherein said electrolyzer module comprises a pressure regulating device coupled to one of the anode and cathode of said at least one electrolyzer cell, wherein gas at the other of the anode and cathode of said at least one electrolyzer cell is used to control the operation of said pressure regulating device, such that a substantially constant differential pressure between said anode and cathode of said at least one electrolyzer cell is maintained.

7. The system of claim 6, wherein said pressure regulating device is a mechanical regulating valve.

8. The system of claim 7, wherein said pressure regulating device is a dome loading pressure regulating valve.

9. The system of claim 8, wherein said pressure regulating device is a dome loading back pressure regulating valve.

10. The system of claim 9, wherein said pressure regulating device comprises an inlet for receiving gas from the anode of said at least one electrolyzer cell, wherein said pressure regulating device receives a dome load signal from the cathode of said at least one electrolyzer cell, and wherein in operation, said pressure regulating device opens to allow gas to flow from said inlet to an outlet of said pressure regulating device when the pressure at said inlet exceeds the pressure of said dome load signal.

11. The system of claim 9, wherein said pressure regulating device comprises an inlet for receiving gas from the cathode of said at least one electrolyzer cell, wherein said pressure regulating device receives a dome load signal from the anode of said at least one electrolyzer cell, and wherein in operation, said pressure regulating device opens to allow gas to flow from said inlet to an outlet of said pressure regulating device when the pressure at said inlet exceeds the pressure of said dome load signal.

12. The system of claim 1, wherein said electrolyzer module comprises a drying unit coupled to the cathode of said at least one electrolyzer cell, and wherein said electrolyzer module further comprises a pressure regulating device coupled between said cathode and said drying unit, such that pressure fluctuations of said drying unit are isolated from said cathode.

13. The system of claim 12, wherein said electrolyzer module further comprises an additional pressure regulating device coupled between said drying unit and said hydrogen storage module, such that pressure fluctuations of said drying unit are also isolated from said hydrogen storage module.

14. The system of claim 1, wherein said electrolyzer module comprises a pump adapted to provide water to said at least one electrolyzer cell at a flow rate and at sufficiently low pressure so that a determined differential pressure limit is not exceeded, and wherein in operation, water is supplied to said at least one electrolyzer cell in said hydrogen generation mode by said pump at a rate associated with a desired rate of hydrogen production by said electrolyzer module.

15. The system of claim 14, wherein said pump is a centrifugal pump.

16. The system of claim 1, wherein said fuel cell power module comprises at least one oxidant supplying device to supply an oxygen-containing gas to said at least one fuel cell, such that the rate at which said oxygen-containing gas is supplied by said at least one oxidant supplying device is a function of at least the current draw on said at least one fuel cell during operation of said at least one fuel cell in said electricity generation mode.

17. The system of claim 16, wherein said at least one oxidant supplying device comprises one or more air blowers.

18. The system of claim 16, wherein the rate at which said oxygen-containing gas is supplied by said at least one oxidant supplying device is also a function of stoichiometric data predetermined for said system.

19. The system of claim 16, wherein said fuel cell power module further comprises a voltage monitoring device coupled to said at least one fuel cell, wherein the rate at which said oxidant-containing gas is supplied by said at least one oxidant supplying device is also dependent on measurements obtained by said voltage monitoring device.

20. The system of claim 1, wherein said fuel cell power module comprises a pressure regulating device coupled to one of the anode and cathode of said at least one fuel cell, wherein gas at the other of the anode and cathode of said at least one fuel cell is used to control the operation of said pressure regulating device, such that a substantially constant differential pressure between said anode and cathode of said at least one fuel cell is maintained.

21. The system of claim 20, wherein said pressure regulating device is a mechanical regulating valve.

22. The system of claim 21, wherein said pressure regulating device is a bias dome loading pressure regulating valve.

23. The system of claim 20, wherein said pressure regulating device is a forward pressure regulating valve.

24. The system of claim 23, wherein said pressure regulating device is a dome loading forward pressure regulating valve.

25. The system of claim 24, wherein said pressure regulating device is a bias dome loading forward pressure regulating valve that comprises an inlet for receiving gas from a hydrogen supply and an outlet to provide hydrogen to the anode of said at least one fuel cell, wherein said pressure regulating device receives a dome load signal from the cathode of said at least one fuel cell, and wherein in operation, said pressure regulating device opens to allow gas to flow from said inlet to said outlet of said pressure regulating device when the pressure at said outlet drops below a biased pressure value, said biased pressure value being the sum of the pressure of said dome load signal and a bias setting value.

26. The system of claim 1, wherein said electrolyzer module comprises a determined number of electrolyzer cells having an active area such that said at least one electrolyzer cell can be directly connected to a power source of said vehicle to receive power from said power source in hydrogen generation mode, and wherein said fuel cell power module comprises a determined number of fuel cells having an active area such that said at least one fuel cell can be directly connected to supply power to said vehicle in electricity generation mode.

27. The system of claim 1, wherein said hydrogen storage module comprises a storage unit of one or more cylinders, each containing metal hydrides, for storing hydrogen generated by said at least one electrolyzer cell; and wherein said hydrogen storage module further comprises a water circulation system coupled to said storage unit and said at least one fuel cell, wherein water is circulated in said water circulation system in at least one of said hydrogen generation and electricity generation modes.

28. The system of claim 27, wherein waste heat generated by said at least one fuel cell is transferred to said water in said electricity generation mode, to enhance desorption of hydrogen in said hydrogen storage module.

29. The system of claim 27, wherein said storage unit is sized such that the waste heat generated by said at least one fuel cell is sufficient to desorb hydrogen at a specified rate of hydrogen flow.

30. The system of claim 27, wherein heat generated by said hydrogen storage module in said hydrogen generation mode is transferred to said water, to preheat said at least one fuel cell.

31. The system of claim 30, wherein said water circulation system comprises a water jacket through which water may circulate, wherein said water jacket surrounds at least a part of said storage unit, to facilitate transfers of heat between said storage unit and said water.

32. The system of claim 30, wherein said water circulation system comprises an internal cooling loop within said storage unit through which water may circulate, to facilitate transfers of heat between said storage unit and said water.

33. An electrolyzer module comprising:
a. at least one electrolyzer cell, said at least one electrolyzer cell having an anode and a cathode;
b. a water supply for supplying water to said at least one electrolyzer cell;
c. a power supply for supplying power to said at least one electrolyzer cell;
d. one or more connections for coupling said at least one electrolyzer cell to a hydrogen storage module; and
e. at least one temperature regulation device coupled to said at least one electrolyzer cell for varying the operating temperature of said at least one electrolyzer cell, such that the current draw of said at least one electrolyzer cell is controlled.

34. The electrolyzer module of claim 33, wherein said at least one temperature regulation device comprises a heat exchanger for varying the temperature of water entering said at least one electrolyzer cell.

35. The electrolyzer module of claim 33, wherein said at least one electrolyzer cell operates at a substantially constant operating voltage while said operating temperature thereof is varied, and wherein said operating temperature thereof is varied by said at least one temperature regulation device such that variations in said current draw is a function of variations in said operating temperature.

36. The electrolyzer module of claim 33, wherein said at least one electrolyzer cell operates at a varying operating voltage while said operating temperature is varied, and wherein said operating temperature thereof is varied by said at least one temperature regulation device such that said current draw is maintained substantially constant.

37. An electrolyzer module comprising:
a. at least one electrolyzer cell, said at least one electrolyzer cell having an anode and a cathode;
b. a water supply for supplying water to said at least one electrolyzer cell;
c. a power supply for supplying power to said at least one electrolyzer cell;
d. one or more connections for coupling said at least one electrolyzer cell to a hydrogen storage module; and
e. a pressure regulating device coupled to one of the anode and cathode of said at least one electrolyzer cell, wherein gas at the other of the anode and cathode of said at least one electrolyzer cell is used to control the operation of said pressure regulating device, such that a substantially constant differential pressure between said anode and cathode of said at least one electrolyzer cell is maintained.

38. The electrolyzer module of claim 37, wherein said pressure regulating device is a mechanical regulating valve.

39. The electrolyzer module of claim 38, wherein said pressure regulating device is a dome loading pressure regulating valve.

40. The electrolyzer module of claim 39, wherein said pressure regulating device is a dome loading back pressure regulating valve.

41. The electrolyzer module of claim 40, wherein said pressure regulating device comprises an inlet for receiving gas from the anode of said at least one electrolyzer cell, wherein said pressure regulating device receives a dome load signal from the cathode of said at least one electrolyzer cell, and wherein in operation, said pressure regulating device opens to allow gas to flow from said inlet to an outlet of said pressure regulating device when the pressure at said inlet exceeds the pressure of said dome load signal.

42. The electrolyzer module of claim 40, wherein said pressure regulating device comprises an inlet for receiving gas from the cathode of said at least one electrolyzer cell, wherein said pressure regulating device receives a dome load signal from the anode of said at least one electrolyzer cell, and wherein in operation, said pressure regulating device opens to allow gas to flow from said inlet to an outlet of said pressure regulating device when the pressure at said inlet exceeds the pressure of said dome load signal.

43. An electrolyzer module comprising:
a. at least one electrolyzer cell, said at least one electrolyzer cell having an anode and a cathode;
b. a water supply for supplying water to said at least one electrolyzer cell;
c. a power supply for supplying power to said at least one electrolyzer cell;
d. one or more connections for coupling said at least one electrolyzer cell to a hydrogen storage module;
e. a drying unit coupled to the cathode of said at least one electrolyzer cell; and
f. a pressure regulating device coupled between said cathode and said drying unit, such that pressure fluctuations of said drying unit are isolated from said cathode.

44. The electrolyzer module of claim 43, further comprising an additional pressure regulating device coupled between said drying unit and said hydrogen storage module, such that pressure fluctuations of said drying unit are also isolated from said hydrogen storage module.

45. An electrolyzer module comprising:
a. at least one electrolyzer cell, said at least one electrolyzer cell having an anode and a cathode;
b. a water supply for supplying water to said at least one electrolyzer cell;
c. a power supply for supplying power to said at least one electrolyzer cell;
d. one or more connections for coupling said at least one electrolyzer cell to a hydrogen storage module; and
e. at least one pump adapted to provide water to said at least one electrolyzer cell at a flow rate and at sufficiently low pressure so that a determined differential pressure limit is not exceeded, wherein in operation, water is supplied to said at least one electrolyzer cell by said pump at a rate associated with a desired rate of hydrogen production by said electrolyzer module.

46. The electrolyzer module of claim 45, wherein said at least one pump comprises a centrifugal pump.

47. A fuel cell power module comprising:
a. at least one fuel cell, said at least one fuel cell having an anode and a cathode;
b. one or more first connections for coupling said at least one fuel cell to a hydrogen storage module containing hydrogen;
c. one or more second connections for coupling said at least one fuel cell to a load to be driven by said at least one fuel cell; and
d. an oxidant supplying device for supplying oxygen-containing gas to said at least one fuel cell, wherein said oxidant supplying device supplies oxygen-containing gas to said at least one fuel cell at a rate that is a function of at least the current draw on said at least one fuel cell during operation of said at least one fuel cell.

48. The fuel cell power module of claim 47, wherein said at least one oxidant supplying device comprises one or more air blowers.

49. The fuel cell power module of claim 47, wherein the rate at which said oxygen-containing gas is supplied by said at least one oxidant supplying device is also a function of predetermined stoichiometric data.

50. The fuel cell power module of claim 47, further comprising a voltage monitoring device coupled to said at least one fuel cell, wherein the rate at which said oxygen-containing gas is supplied by said at least one oxidant supplying device is also dependent on measurements obtained by said voltage monitoring device.

51. A fuel cell power module comprising:
a. at least one fuel cell, said at least one fuel cell having an anode and a cathode;
b. one or more first connections for coupling said at least one fuel cell to a hydrogen storage module containing hydrogen;
c. one or more second connections for coupling said at least one fuel cell to a load to be driven by said at least one fuel cell;
d. an oxidant supplying device for supplying oxygen-containing gas to said at least one fuel cell; and
e. a pressure regulating device coupled to one of the anode and cathode of said at least one fuel cell, wherein gas at the other of the anode and cathode of said at least one fuel cell is used to control the operation of said pressure regulating device, such that a substantially constant differential pressure between said anode and cathode of said at least one fuel cell is maintained.

52. The fuel cell power module of claim 51, wherein said pressure regulating device is a mechanical regulating valve.

53. The fuel cell power module of claim 52, wherein said pressure regulating device is a bias dome loading pressure regulating valve.

54. The fuel cell power module of claim 51, wherein said pressure regulating device is a forward pressure regulating valve.

55. The fuel cell power module of claim 54, wherein said pressure regulating device is a dome loading forward pressure regulating valve.

56. The fuel cell power module of claim 55, wherein said pressure regulating device is a bias dome loading forward pressure regulating valve that comprises an inlet for receiving gas from said hydrogen storage module and an outlet to provide hydrogen to the anode of said at least one fuel cell, wherein said pressure regulating device receives a dome load signal from the cathode of said at least one fuel cell, and wherein in operation, said pressure regulating device opens to allow gas to flow from said inlet to said outlet of said pressure regulating device when the pressure at said outlet drops below a biased pressure value, said biased pressure value being the sum of the pressure of said dome load signal and a bias setting value.

57. A hydrogen storage module for coupling to a fuel cell power module, said hydrogen storage module comprising:
a. a storage unit of one or more cylinders, each containing metal hydrides, for storing hydrogen; and
b. a water circulation system coupled to said storage unit and said at least one fuel cell, wherein water is circulated in said water circulation system.

58. The hydrogen storage module of claim 57, wherein in operation of said fuel cell power module, waste heat generated by at least one fuel cell of said fuel cell power module is transferred to said water, to enhance desorption of hydrogen in said hydrogen storage module.

59. The hydrogen storage module of claim 58, wherein said storage unit is sized such that the waste heat generated by said at least one fuel cell is sufficient to desorb hydrogen at a specified rate of hydrogen flow.

60. The hydrogen storage module of claim 57, wherein heat generated by said hydrogen storage module when said hydrogen storage module is being filled is transferred to said water, to preheat said at least one fuel cell.

61. The hydrogen storage module of claim 57, wherein said water circulation system comprises a water jacket through which water may circulate, wherein said water jacket surrounds at least a part of said storage unit, to facilitate transfers of heat between said storage unit and said water.

62. The hydrogen storage module of claim 57, wherein said water circulation system comprises an internal cooling loop within said storage unit through which water may circulate, to facilitate transfers of heat between said storage unit and said water.

63. An electrolyzer module for use in a vehicle comprising:
a. at least one electrolyzer cell, said at least one electrolyzer cell having an anode and a cathode;
b. a water supply for supplying water to said at least one electrolyzer cell;
c. a power supply for supplying power to said at least one electrolyzer cell; and
d. one or more connections for coupling said at least one electrolyzer cell to a hydrogen storage module;
wherein said electrolyzer module comprises a determined number of electrolyzer cells having an active area such that said at least one electrolyzer cell can be directly connected to a power source of a vehicle to receive power from said power source.

64. A fuel cell power module for use in a vehicle comprising:
a. at least one fuel cell, said at least one fuel cell having an anode and a cathode;
b. one or more first connections for coupling said at least one fuel cell to a hydrogen storage module containing hydrogen;
c. one or more second connections for coupling said at least one fuel cell to a load to be driven by said at least one fuel cell; and
d. an oxidant supplying device for supplying oxygen-containing gas to said at least one fuel cell;
wherein said fuel cell power module comprises a determined number of fuel cells having an active area such that said at least one fuel cell can be directly connected to supply power to said vehicle.
